(19) United States
(12) Patent Application Publication
(10) Pub. No.: US 2025/0256566 A1
(43) Pub. Date: Aug. 14, 2025

(54) ACTIVE AND PASSIVE OVERRUNNING WHEEL END DISCONNECT

(71) Applicant: Means Industries, Inc., Saginaw, MI (US)

(72) Inventor: Steven M. Thomas, Saginaw, MI (US)

(21) Appl. No.: 19/100,391

(22) PCT Filed: Oct. 18, 2024
(86) PCT No.: PCT/US2024/051871

§ 371 Date: Jan. 31, 2025

Related U.S. Application Data
(60) Provisional application No. 63/591,276, filed on Oct. 18, 2023.

(51) Int. Cl. B60K 17/02; B60B 27/04; B60B 35/12; F16D 41/12

(52) U.S. Cl. CPC B60K 17/02; F16D 41/12

(57) ABSTRACT

An apparatus includes an axle, a wheel hub, and an active and passive overrunning wheel hub clutch disposed between the axle and the wheel hub. An active and passive overrunning wheel hub clutch includes a clutch hub, a wheel hub, an active clutch between the clutch hub and the wheel hub, and a passive clutch between the clutch hub and the wheel hub. A wheel end includes a wheel hub cover, and an active and passive overrunning wheel hub clutch coupled to the wheel hub cover.

### TECHNICAL FIELD

This disclosure relates generally to vehicles and, more particularly, to drivetrains of vehicles, axles and wheel end systems of drivetrains, wheel hubs and wheel hub clutches of wheel end systems, and components for wheel hub clutches.

### BACKGROUND

Wheeled vehicles include wheels and one or more prime movers, like an internal combustion engine and/or an electric motor, to rotatably drive the wheels. Some such vehicles may drive the wheels directly with an electric motor. Other such vehicles also or instead may include a drivetrain located between the prime mover and the wheels and including an axle to change drive rotation from a longitudinal direction along a length of the vehicle to a transverse direction. The latter vehicles also may include a drive shaft coupled to an input side of the axle and axle shafts extending transversely away from the axle and coupled to the wheels. Some vehicles further may include multiple sets of wheels and multiple axles, usually two rear axles and two sets of wheels driven via the axles. In any case, all such wheels include wheel hubs that couple the wheels (e.g., wheel rim and tire mounted on the rim) to a drivetrain axle shaft, an electric motor shaft, or any other suitable shaft or torque input element. Some wheel hubs include wheel hub clutches configured to disconnect (and reconnect) wheels from a prime mover, for example, to improve fuel economy when a vehicle with multiple driven rear axles is traveling at highway speeds, or to convert a vehicle from four-wheel-drive mode to two-wheel-drive mode.

But currently available wheel hub clutches may be too bulky or costly, or of poor quality or reliability. In one specific example, such clutches do not favor remote automatic disconnectability between the prime mover and the wheels, and are located too distant from the wheels such that the clutches are not optimal for driveline efficiency. Likewise, currently available wheel hub clutches may lack certain functionality. In another specific example, many such clutches have on/off or engaged/disengaged capability wherein a wheel hub clutch will not actively engage an axle shaft to a wheel hub until a drivetrain speed closely matches a wheel speed, but do not have overrunning or freewheeling clutching capability wherein a wheel hub clutch passively engages an axle shaft to a wheel hub at the moment the drivetrain speed matches the wheel speed.

### SUMMARY

An apparatus includes an axle, a wheel hub, and an active and passive overrunning wheel hub clutch disposed between the axle and the wheel hub.

An active and passive overrunning wheel hub clutch includes a clutch hub, a wheel hub, an active clutch between the clutch hub and the wheel hub, and a passive clutch between the clutch hub and the wheel hub.

A wheel end includes a wheel hub cover, and an active and passive overrunning wheel hub clutch coupled to the wheel hub cover.

### BRIEF DESCRIPTION OF THE DRAWINGS

FIG. 1 is an exploded perspective view according to an illustrative embodiment of a wheel end including an illustrative embodiment of a dual plane active and passive overrunning wheel end disconnect.

FIG. 2 is another exploded perspective view of the wheel end and disconnect of FIG. 1.

FIG. 3A is a cross-sectional view of the wheel end and disconnect of FIG. 1, illustrating an active strut in a nondeployed position.

FIG. 3B is a cross-sectional view of the wheel end and disconnect of FIG. 1, illustrating the active strut in a deployed position.

FIG. 4A is an exploded perspective view according to another illustrative embodiment of a wheel end including an illustrative embodiment of an active radial and passive planar overrunning wheel end disconnect.

FIG. 4B is an enlarged fragmentary view of the wheel end disconnect of FIG. 4A, illustrating an active strut biased toward a deployed position.

FIG. 4C is an enlarged fragmentary view of an alternative wheel end disconnect similar to that shown in FIG. 4A, but illustrating the active strut biased toward a nondeployed position.

FIG. 5 is another exploded perspective view of the wheel end and disconnect of FIG. 4.

FIGS. 6A and 6B are cross-sectional views of the wheel end and disconnect of FIG. 4.

FIG. 6C is a fragmentary axial view of the wheel end and disconnect of FIG. 4.

FIG. 7 is an exploded perspective view according to a further illustrative embodiment of a wheel end including an illustrative embodiment of an active and passive radial overrunning wheel end disconnect.

FIG. 8 is another exploded perspective view of the wheel end and disconnect of FIG. 7.

FIG. 9A is a cross-sectional view of the wheel end and disconnect of FIG. 7.

FIG. 9B is a fragmentary axial view of the wheel end and disconnect of FIG. 7.

FIG. 10 is an exploded perspective view according to an additional illustrative embodiment of a wheel end including an illustrative embodiment of a single plane active and passive overrunning wheel end disconnect.

FIG. 11 is another exploded perspective view of the wheel end and disconnect of FIG. 10.

FIG. 12 is a cross-sectional view of the wheel end and disconnect of FIG. 10.

FIG. 13 is a fragmentary end view of the wheel end and disconnect of FIG. 10, illustrating active and passive planar struts.

FIG. 14 is a fragmentary end view of the wheel end and disconnect of FIG. 10, illustrating notches in a notch plate portion of a wheel end cover.

FIG. 15 is an exploded perspective view according to yet another illustrative embodiment of a wheel end including an illustrative embodiment of an active planar and passive radial overrunning wheel end disconnect.

FIG. 16 is another exploded perspective view of the wheel end and disconnect of FIG. 15.

FIG. 17A is a cross-sectional view of the wheel end and disconnect of FIG. 15, illustrating a passive radial clutch portion.

FIG. 17B is a cross-sectional view of the wheel end and disconnect of FIG. 15, illustrating an active planar clutch portion.

FIG. 18 is a schematic diagram according to an illustrative embodiment of a vehicle and including a general embodiment of a wheel end and disconnect generic to the illustrative embodiments of FIGS. 1-17B.

### DETAILED DESCRIPTION

In contrast to complex conventional wheel hub clutches or wheel end disconnects, the present disclosure includes a relatively simple wheel hub clutch or wheel end disconnect configured to allow a wheel hub to be operatively engaged and disengaged from an axle of a driveline of a vehicle and having an overrunning or freewheeling mode. In general, the presently disclosed apparatus includes an active and passive overrunning wheel hub clutch including a wheel hub, a clutch hub, an active clutch between the clutch hub and the wheel hub, and a passive clutch between the clutch hub and the wheel hub. The active and passive overrunning wheel hub clutch enables a one way clutch freewheeling or overrunning mode wherein a drivetrain that is rotating relatively slower than vehicle wheels can gradually increase speed and catch up to the rotational speed of the wheels and passively engage the vehicle wheels to impart drive force to the wheels. The wheel hub clutches disclosed herein may be used to engage, disengage, and freewheel, a wheel end, for example, a wheel end like that described in application PCT/US2022/38804, published as WO 2023/048826, filed on Jul. 29, 2022, docket number AAGCM001-US, corresponding to issued U.S. Pat. No. 12,054,041, the contents of which are hereby incorporated herein by reference in their entireties. The novelty of the active and passive overrunning wheel hub clutches and wheel end disconnects lend novelty to a wheel end system, axle, drivetrain, and vehicle, all including the novel wheel hub clutches. The illustrated clutch embodiments shown in the drawings are all shown at a wheel end outboard location, but could also be positioned at a wheel end inboard location and still provide the same or similar benefits, as taught and disclosed in the '804 application.

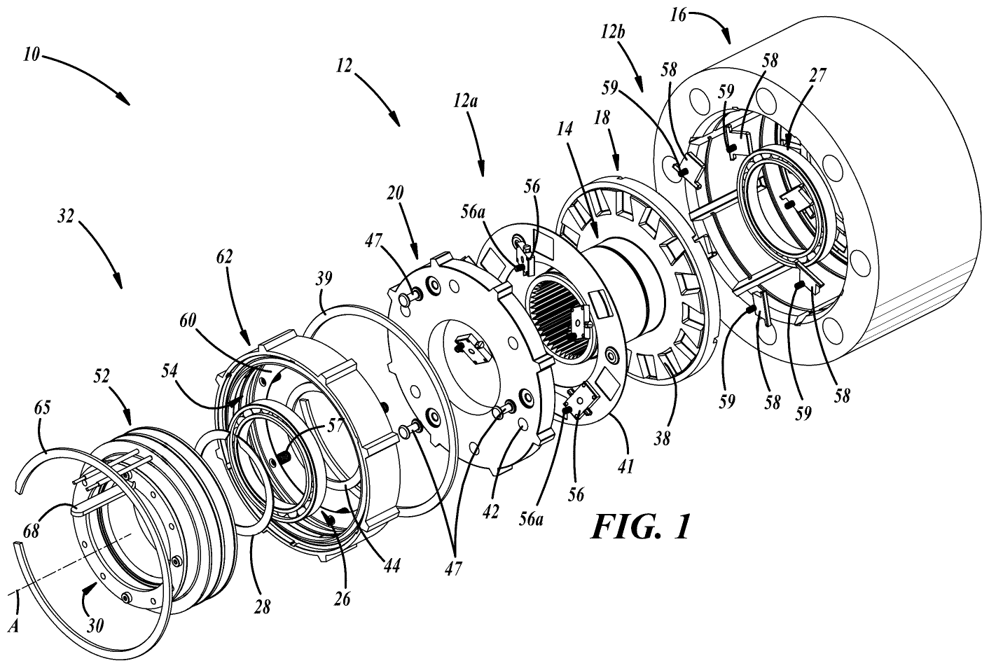

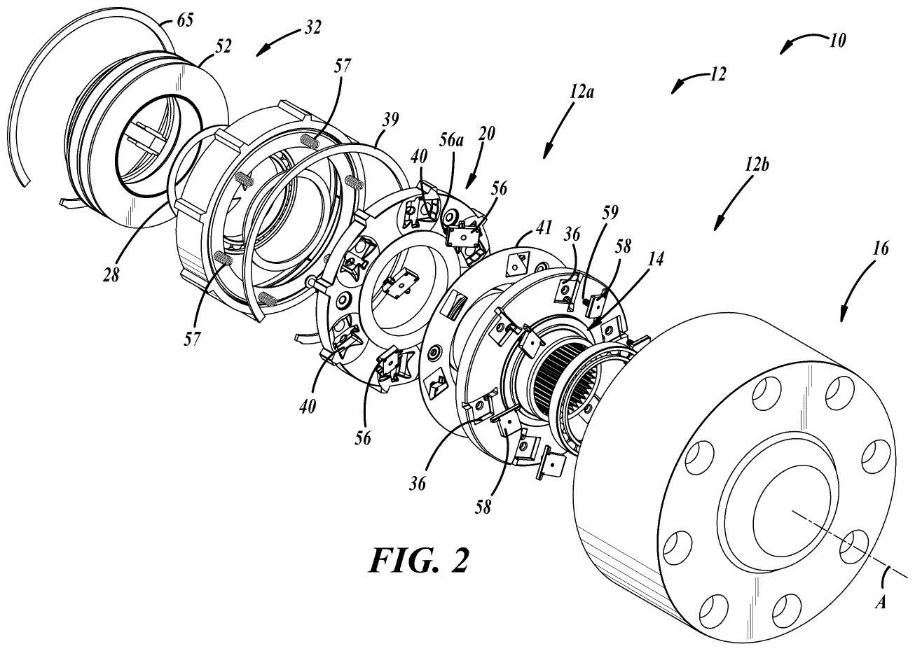

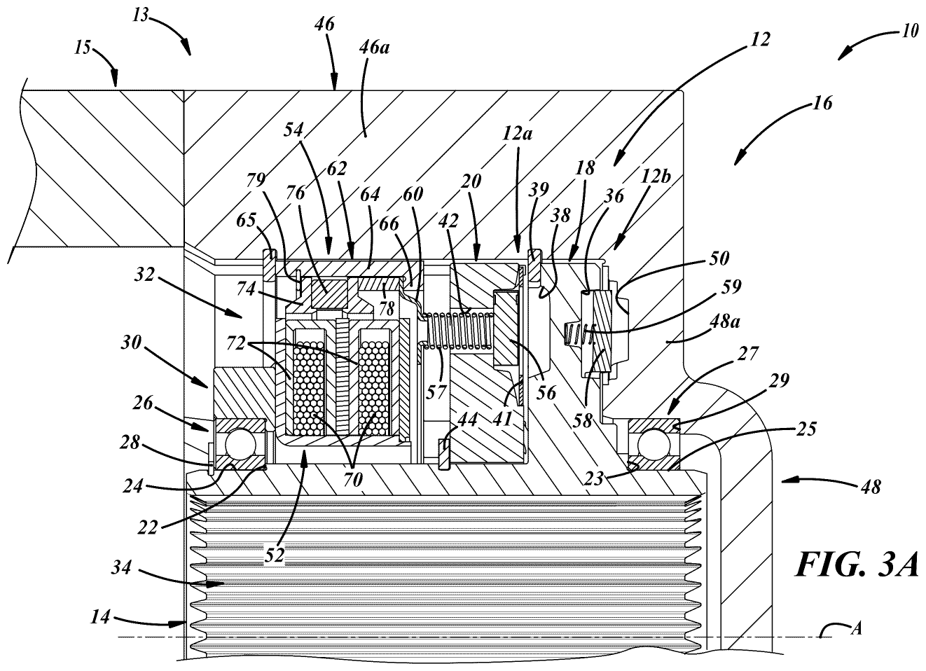

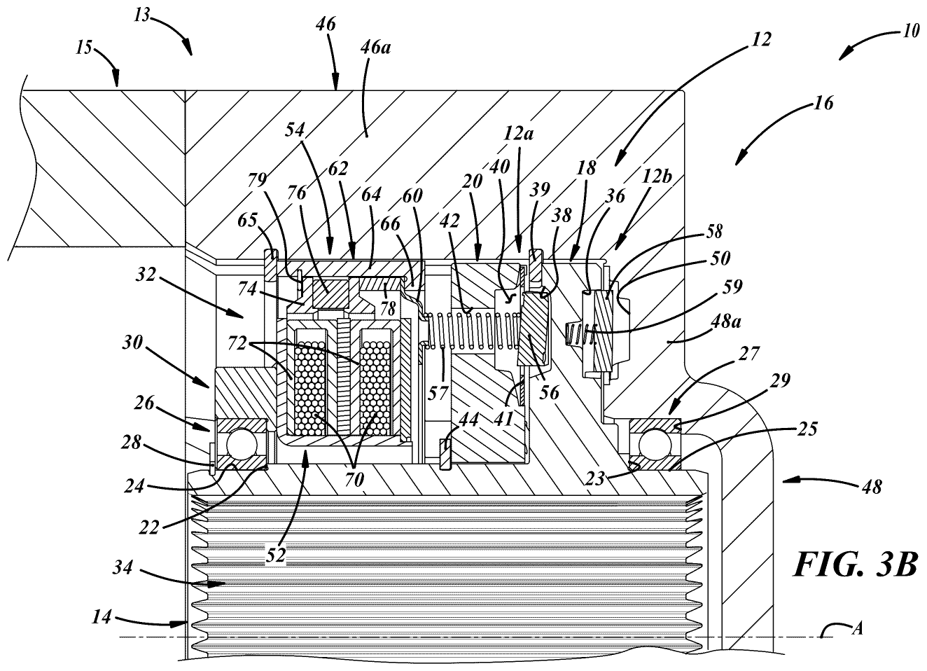

Referring specifically to the drawings, FIGS. 1 and 2 show a fragmentary sectional view of an illustrative embodiment of a wheel end 10 including an illustrative embodiment of a wheel hub clutch 12. The wheel end 10 includes a clutch hub 14 configured to be coupled to an axle shaft (not separately shown), a wheel hub 13 (FIG. 3A) including a wheel hub body 15 (FIG. 3A) and a wheel hub cover 16 coupled to the wheel hub body 15 by bolts, studs, or any other suitable fasteners (not shown), and the wheel hub clutch 12 disposed between the clutch hub 14 and the wheel hub 13. In particular, the wheel hub clutch 12 is disposed between the clutch hub 14 and the wheel hub cover 16, to couple and decouple the wheel hub 13 relative to the clutch hub 14. The wheel end 10 is rotatable about a rotational axis A of the wheel end 10. The wheel hub clutch 12 includes the clutch hub 14, a first clutch component or race 18 coupled to the clutch hub 14, and a second clutch component or race 20 coupled to the wheel hub cover 16. The wheel hub clutch 12 includes an active clutch 12a that is operatively disposed between the first and second races 18, 20, and a passive clutch 12b that is operatively disposed between the first race 18 and the wheel hub cover 16.

With reference now to FIGS. 3A and 3B, the clutch hub 14 may include an inboard shoulder 22 and an adjacent inboard bearing journal 24 at an inboard end of the clutch hub 14 for carrying an inboard bearing 26 between the inboard shoulder 22 and a snap ring 28 or other retention element that may be coupled to the clutch hub 14 at a location inboard of the inboard shoulder 22. The inboard bearing 26 may support a stator support 30 for a clutch actuator 32. The clutch hub 14 may include an internal spline 34 for splined coupling to an axle shaft (not shown). The clutch hub 14 also may include an outboard shoulder 23 and an adjacent outboard bearing journal 25 at an outboard end of the clutch hub 14 for carrying an outboard bearing 27 between the outboard shoulder 23 and a corresponding shoulder 29 of the wheel hub cover 16.

The first race (or first coupling member) 18 may be a combination axial pocket plate and axial notch plate, with passive pockets 36 in a passive pocket surface on an outboard side of the first race 18 and active notches 38 in an active notch surface on an inboard side of the first race 18. In the illustrated embodiment, the first race 18 may be integral with the clutch hub 14 such that the clutch hub 14 and the first race 18 may be unitary. In other embodiments, the first race 18 may be splined or otherwise coupled against relative rotation with respect to the clutch hub 14. The first race 18 may be axially retained with respect to the wheel hub cover 16 by a snap ring 39 or other retention ring carried in a corresponding groove of the wheel hub cover 16.

The second race (or second coupling member) 20 may be a pocket plate, with active pockets 40 on an outboard side and actuator element passages 42 extending through the race 20 between the outboard side and an inboard side and in communication with the active pockets 40. A strut retainer 41 may be coupled to the second race 20. The second race 20 may be axially retained with respect to the clutch hub 14 by a snap ring 44 or other retention ring carried in a corresponding groove of the clutch hub 14. The strut retainer 41 may be fastened to the second race 20 by rivets 47 (FIG. 1), or bolts, or any other suitable fasteners.

The wheel hub cover 16 may include a cover sidewall 46, and a cover endwall 48 coupled to the cover sidewall 46. The cover endwall 48 may be coupled to the cover sidewall 46 by being unitary therewith, as illustrated, or by being splined, fastened, or otherwise separately connected thereto in any other suitable manner. In any event, a portion of the wheel hub cover 16 serves as a clutch race, in particular, a notch plate, with passive notches 50 on an inboard side. The wheel hub cover 16 may be a cup-shaped member, wherein the cover sidewall 46 includes a longitudinally extending circumferential wall 46a that may be internally splined, and wherein the cover endwall 48 includes a transversely extending axial wall 48a that may carry the passive notches 50.

The clutch actuator 32 includes a stator 52 that is supported by the stator support 30 carried by the bearing 26 on a radially outward side of the bearing 26. The clutch actuator 32 also includes a translator 54 carried radially outward of the stator 52 and radially inward of a portion, for example, the cover sidewall 46, of the wheel hub cover 16.

The wheel hub clutch illustrated in FIGS. 1 through 3B is a dual plane active and passive overrunning clutch. Example embodiments of a dual plane clutch are described in U.S. patent application Ser. No. 18/132,800, filed on Apr. 10, 2023, docket number MNS142-US, issued as U.S. Pat. No. 12,092,172, assigned to the assignee hereof, the contents of which is hereby incorporated herein by reference in its entirety.

The second race 20 is coupled to the longitudinally extending circumferential wall 46a of the wheel hub cover 16 against relative rotation therebetween, and the first race 18 is coupled to the clutch hub 14 and is disposed axially between the second race 20 and the transversely extending axial wall 48a of the wheel hub cover 16. More specifically, the second race 20 may be splined to the longitudinally extending circumferential wall 46a of the wheel hub cover 16. The second race 20 includes the active pockets 40, which are axial pockets in an axially outboard facing active pocket surface of the second race 20. The transversely extending axial wall 48a of the wheel hub cover 16 includes the passive notches 50, which are axial notches in an axially inboard facing passive notch surface of the transversely extending axial wall 48a of the wheel hub cover 16. Also more specifically, the first race 18 may be unitary with the clutch hub 14 and includes the active notches 38 in an active notch surface facing the active pocket surface of the second race 20, and the passive pockets 36 in the passive pocket surface facing the passive notch surface of the transversely extending axial wall 48a of the wheel hub cover 16.

The active clutch 12a includes one or more active struts 56 between the active pockets 40 in the active pocket surface of the second race 20 and the active notches 38 in the active notch surface of the first race 18. The active struts 56 may be biased to a nondeployed position by return springs 56a (FIG. 1). As used herein, the term nondeployed is synonymous with undeployed, off, deactivated, unactivated, disengaged, unengaged, and like terminology. The active struts 56 of the active clutch 12a couple the second race 20 and the first race 18 in a second direction of rotation only. The active clutch 12a also may include active actuator elements that may include active springs 57, wherein the clutch actuator 32 may include the active springs 57 and, in any case, moves the active springs 57 to, in turn, move the active struts 56 pivotally to a deployed position between the second race 20 and the first race 18 such that the first race 18 becomes coupled to the second race 20 in the second direction of rotation. As used herein, the term deployed is synonymous with activated, on, engaged, and like terminology.

The passive clutch 12b includes one or more passive struts 58 between the passive pockets 36 of the first race 18 and the passive notches 50 in the transversely extending axial wall 48a of the wheel hub cover 16. The passive struts 58 of the passive clutch 12b couple the first race 18 and the wheel hub cover 16 in a first direction of rotation only and allow the first race 18 to overrun the wheel hub cover 16 in the second direction of rotation that is circumferentially opposite of the first direction of rotation. The passive clutch 12b may include passive actuator elements that may include passive advance springs 59 that bias and move the passive struts 58 toward and to a deployed position between the first race 18 and the wheel hub cover 16 such that the first race 18 becomes coupled to the wheel hub cover 16 in a first (forward) direction of rotation and overruns the wheel hub cover 16 in a second (reverse) direction of rotation.

The clutch actuator 32 includes the stator 52 and the translator 54, and also may include the active springs 57 that may be carried by a spring plate 60 of the clutch actuator 32 that may be moved by the translator 54. The clutch actuator 32 also may include a translator carrier 62 that may be used to carry or house other portions of the translator 54 therein, and that may include an outer cylindrical wall 64 that may be splined to the longitudinally extending circumferential wall 46a of the wheel hub cover 16 and a shoulder 66 that may extend radially inwardly from the outer cylindrical wall 64 to serve as a stop for the spring plate 60. The translator carrier 62 may be axially retained with respect to the wheel hub cover 16 by a snap ring 65 or any other component or feature suitable for such retention.

The stator 52 remains stationary and does not rotate. The stator 52 is supported by the stator support 30 that is carried on the bearing 26 and that may be fastened or otherwise coupled to the stator 52. The stator 52 or the stator support 30 may include an inboard portion that may include an axially extending arm 68 (FIG. 1) that may be fastened to, interengaged with, or otherwise coupled to an axle spindle (not shown) or other non-rotatable or stationary component to prevent the stator 52 from rotating. The stator 52 may include an electromagnet including electromagnetically inductive coils 70 carried between axially spaced fingers of a ferromagnetic housing 72. In other embodiments, the stator 52 may include any suitable structure to produce a magnetic field suitable for use with the wheel hub clutch 12. In the illustrated example, the stator 52 has two electromagnetically inductive coils 70 to create a magnetic flux when one or both electromagnetically inductive coils 70 are energized. The stator 52 applies a first magnetic control force to the translator 54 one way when the electromagnetically inductive coils 70 are energized to cause the translator 54 to move along the rotational axis A. The translator 54 reacts to the magnetic control force by moving the spring plate 60 and corresponding active springs 57 along the rotational axis A. By reversing the current direction in the electromagnetically inductive coils 70, the translator 54 causes the spring plate 60 and corresponding active springs 57 to move in the opposite direction along the rotational axis A.

The translator 54 rotates with the wheel hub cover 16. The translator 54 is supported for translational movement relative to the stator 52 along the rotational axis A between first and second axial end positions, corresponding to different operating modes of the wheel hub clutch 12. The translator 54 may include a magnet carrier 74, a permanent magnet 76 carried by the magnet carrier 74, a spring plate spacer 78 that may be coupled to the spring plate 60 and disposed between the magnet carrier 74 and the spring plate 60, and a snap ring 79 that may fit in a corresponding groove in the outer cylindrical wall 64 of the translator carrier 62 or any other suitable retention element or feature to limit travel of the magnet carrier 74. The spring plate spacer 78 may be unitary with the outer cylindrical wall 64 of the translator carrier 62 as illustrated, or may be a separate component.

The illustrated wheel end includes the wheel hub cover 16, and the active and passive overrunning wheel hub clutch 12 coupled to the wheel hub cover 16 that constitute a cartridge or self-contained assembly. For example, the active and passive overrunning wheel hub clutch 12 may be retained to the wheel hub cover 16 by at least one the several retainer rings. In any event, such a self-contained assembly can be used with a newly designed wheel end or to retrofit an existing wheel end, for example, as an after-market product to upgrade an existing vehicle with additional functionality. Accordingly, an existing wheel hub cover can be removed from an existing wheel hub and an existing axle shaft can be replaced with a longer axle shaft having a splined end, and the new clutch hub 14 can be splined to the longer axle shaft, and the new wheel hub cover 16 can be bolted to the existing wheel hub with longer threaded bolts or studs. The apparatus may be self-contained for easy handling and transport such that all components of the apparatus may be retained together as an assembly by snap rings, screws, and/or any other suitable retainers and/or fasteners.

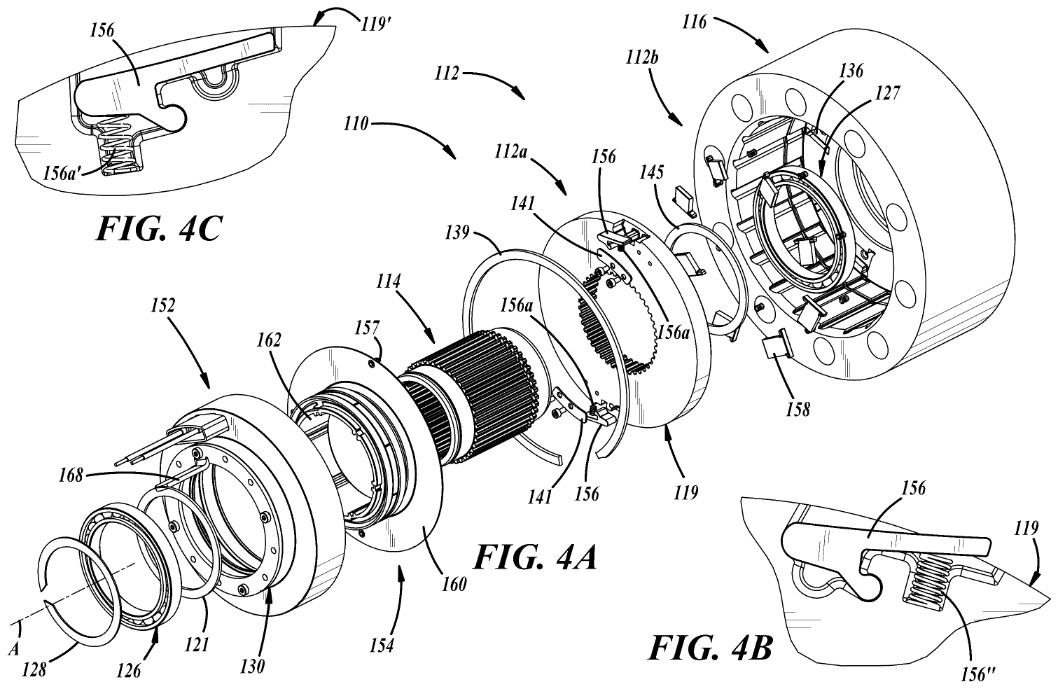

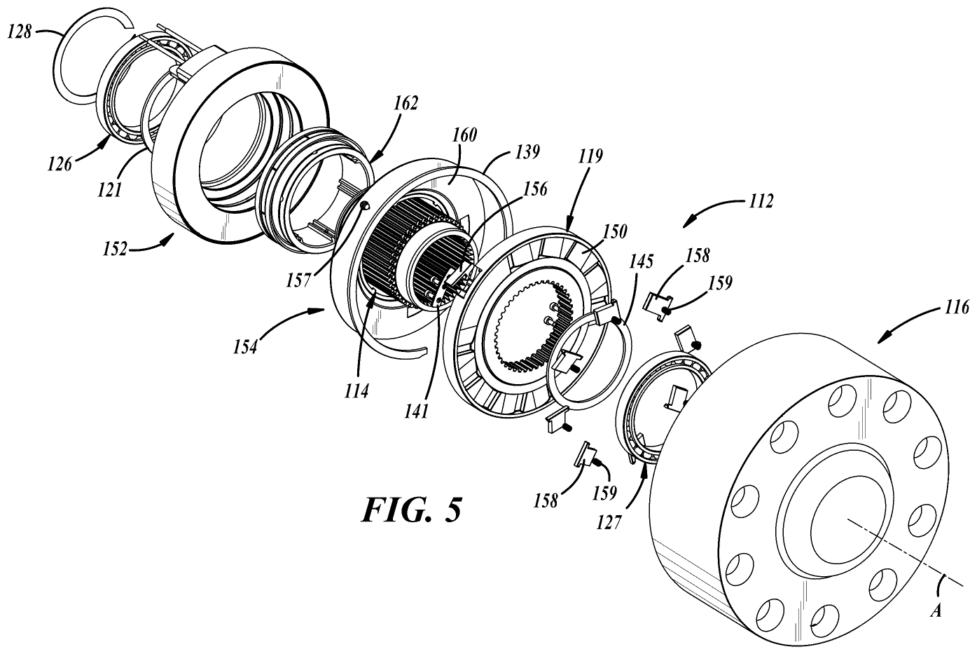

FIGS. 4A-6C show another illustrative embodiment of a wheel end 110 including another embodiment of a wheel hub clutch 112. The wheel hub clutch 112 includes a clutch hub 114, a first or clutch component or race 119 coupled to the clutch hub 114, and a wheel hub cover 116. The wheel hub clutch 112 includes an active clutch 112a that is operatively disposed between the clutch component or race 119 and the wheel hub cover 116, and a passive clutch 112b that is operatively disposed between the clutch component or race 119 and the wheel hub cover 116.

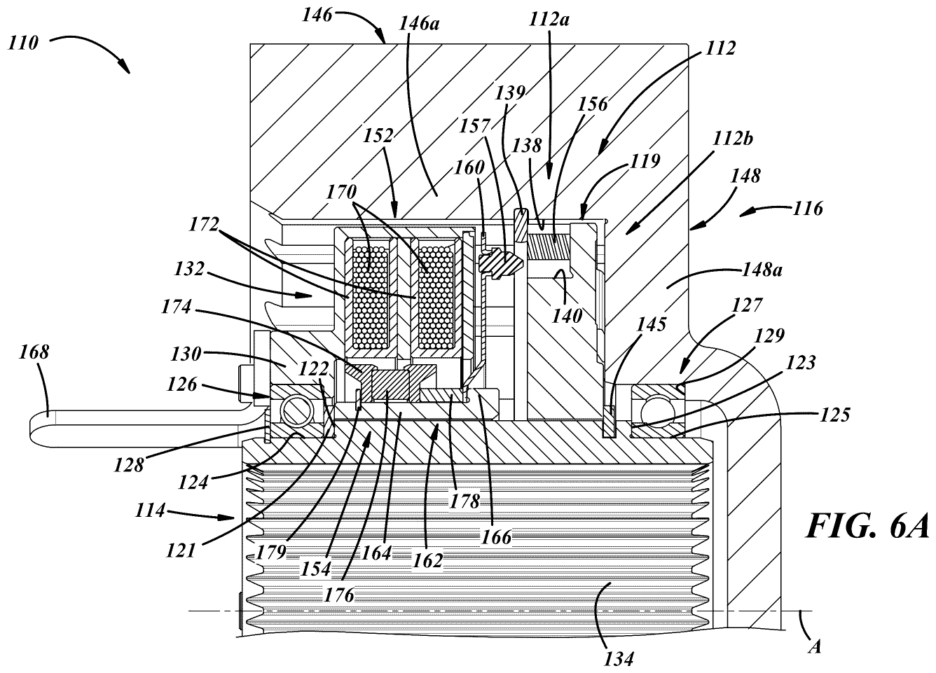

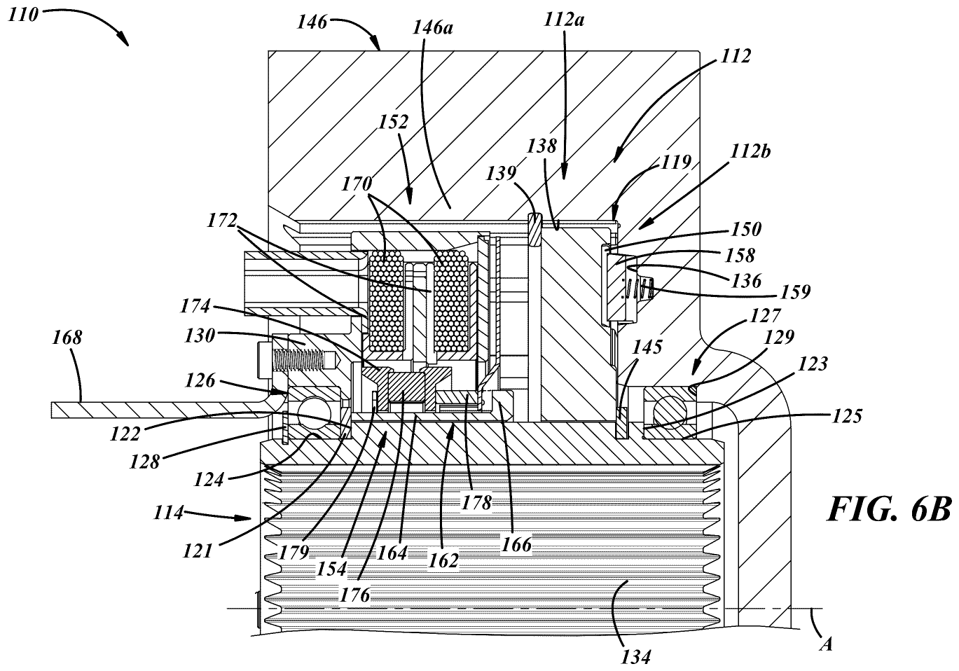

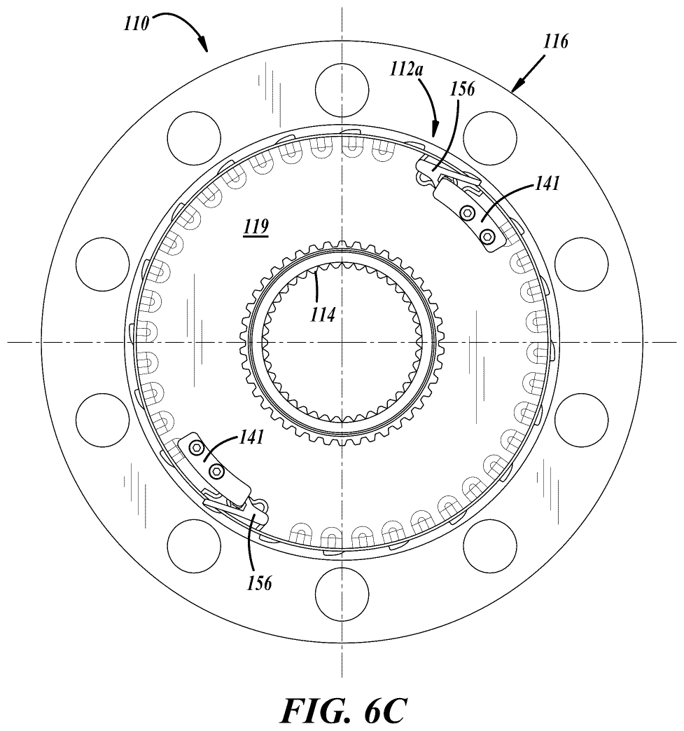

With reference to FIGS. 6A and 6B, the clutch hub 114 may include an inboard shoulder 122, and an adjacent inboard bearing journal 124 at an inboard end of the clutch hub 114 for carrying an inboard bearing 126 between the inboard shoulder 122, a thrust washer 121 located between the inboard shoulder 122 and the inboard bearing 126, and a snap ring 128 or other retention element that may be coupled to the clutch hub 114 at a location inboard of the inboard shoulder 122. The inboard bearing 126 may support a stator support 130 for a clutch actuator 132. The clutch hub 114 may include an internal spline 134 for splined coupling to an axle shaft (not shown). The clutch hub 114 also may include an outboard shoulder 123 and an adjacent outboard bearing journal 125 at an outboard end of the clutch hub 114 for carrying an outboard bearing 127 between the outboard shoulder 123 and a corresponding shoulder 129 of the wheel hub cover 116.

The clutch race 119 may be a combination radial pocket plate and axial pocket plate, with passive axial notches 150 (FIG. 6B) in an outboard side and active radial pockets 140 (FIG. 6A) in a radially outward portion. In the illustrated embodiment, the clutch race 119 may be splined to the clutch hub 114. In other embodiments, the clutch race 119 may be integral with the clutch hub 114 such that the components are unitary, or the clutch race 119 may be otherwise coupled against relative rotation with respect to the clutch hub 114 in any other suitable manner. The clutch race 119 may be axially retained with respect to the wheel hub cover 116 by a snap ring 139 or other retention ring carried in a corresponding groove of the wheel hub cover 116 or other suitable retention component(s) or feature(s) and may be axially retained with respect to the clutch hub 114 by a snap ring 145 or other retention ring carried in a corresponding groove in the clutch hub 114 or other suitable retention component(s) or feature(s).

The clutch actuator 132 includes a stator 152 that may be carried within an inner diameter of the wheel hub cover 116. The clutch actuator 132 also includes a translator 154 that may be carried radially outward of the clutch hub 114 between the stator 152 and the clutch hub 114.

The wheel hub clutch 112 illustrated in FIGS. 4-6B is an active radial and passive planar overrunning clutch. Example embodiments of a relevant clutch are described in U.S. patent application Ser. No. 18/132,800, filed on Apr. 10, 2023, docket number MNS142-US, now U.S. Pat. No. 12,092,172, assigned to the assignee hereof, the contents of which is hereby incorporated herein by reference in its entirety.

The clutch race 119 is coupled to the clutch hub 114 against relative rotation therebetween, and is disposed axially between the clutch actuator 132 and a transversely extending axial wall 148a of the wheel hub cover 116. More specifically, the clutch race 119 may be splined to the clutch hub 114. In other embodiments, the clutch race 119 may be integral with the clutch hub 114 such that the components are unitary. The clutch race 119 includes the radial pockets 140 (FIG. 6A), which are active pockets in a radially outboard facing active pocket surface of the clutch race 119. The transversely extending axial wall 148a of the wheel hub cover 116 includes axial pockets 136 (FIG. 6B), which are passive notches in an axially inboard facing passive notch surface of the transversely extending axial wall 148a of the wheel hub cover 116. Also more specifically, a longitudinally extending circumferential wall 146a of the wheel hub cover 116 includes active notches 138 in an active notch surface facing the active pocket surface of the clutch race 119, such that the wheel hub cover 116 serves as a radial clutch race, more particularly, a notch race. Similarly, the axial notches 150, are passive pockets, in the passive pocket surface facing the passive notch surface of the transversely extending axial wall 148a of the wheel hub cover 116, such that the wheel hub cover serves as an axial or planar clutch race, more particularly a notch plate.

The active clutch 112a includes one or more active struts 156 between the active pockets 140 in the active pocket surface of the clutch race 119 and the active notches 138 in the active notch surface of wheel hub cover 116. The active struts 156 may be biased toward a deployed position by active advance springs 156″ (FIG. 4B). The active struts 156 of the active clutch 112a couple the clutch race 119 in the second direction of rotation only. The active clutch 112a also may include active actuator elements that may include active plungers 157, wherein the clutch actuator 132 may include the active plungers 157 and, in any case, moves the active plungers 157 to, in turn, move the active struts 156 pivotally to an undeployed position between the clutch race 119 and wheel hub cover 116 such that the clutch race 119 becomes uncoupled from the wheel hub cover 116. In another embodiment, illustrated by FIG. 4C, the active struts 156 may be biased toward a nondeployed position by return springs 156′, wherein the active plungers 157 move the active struts 156 pivotally to a deployed position between a clutch race 119′ and the wheel hub cover 116 such that the clutch race 119′ couples to the wheel hub cover 116.

The passive clutch 112b includes one or more passive struts 158 between the passive notches 150 of the clutch race 119 and the passive pockets 136 in the transversely extending axial wall 148a of the wheel hub cover 116. The passive struts 158 of the passive clutch 112b couple the clutch race 119 and the wheel hub cover 116 in a first direction of rotation only and allows the clutch race 119 to overrun the wheel hub cover 116 in a second direction of rotation. The passive struts 158 may be biased to a deployed position by passive advance springs 159 (FIG. 6B). More specifically, the passive clutch 112b also may include passive actuator elements that may include the advance springs 159 that bias and move the passive struts 158 toward and to a deployed position between the clutch race 119 and the wheel hub cover 116 such that the clutch race 119 becomes coupled to the wheel hub cover 116 in a first (forward) direction of rotation and overruns the wheel hub cover 116 in a second (reverse) direction of rotation.

With reference to FIGS. 6A and 6B, the clutch actuator 132 includes the stator 152 and the translator 154, and also may include the active plungers 157 that may be carried by a plunger carrier, for example, a plunger plate 160, of the clutch actuator 132 that may be moved by the translator 154. The clutch actuator 132 also may include a translator carrier 162 that may be used to carry or house other portions of the translator 154 thereon, and that may include an inner cylindrical wall 164 that may be splined to the clutch hub 114 and a shoulder 166 that may extend radially inwardly from the inner cylindrical wall 164 to serve as a stop for the plunger plate 160. The translator carrier 162 may be axially retained with respect to the clutch hub 114 by the thrust washer 121 or any other component or feature suitable for such retention.

The stator 152 remains stationary and does not rotate. The stator 152 is supported by the stator support 130 that is carried on the bearing 126 and that may be an integral or unitary portion of the stator 152 or may be separately fastened or otherwise coupled thereto. The stator 152 or the stator support 130 may include an inboard portion that may include an axially extending arm 168 that may be fastened to, interengaged with, or otherwise coupled to an axle spindle (not shown) or other non-rotatable or stationary component to prevent the stator 152 from rotating. The stator 152 may include an electromagnet including electromagnetically inductive coils 170 carried between axially spaced fingers of a ferromagnetic housing 172. In other embodiments, the stator 152 may include any suitable structure to produce a magnetic field suitable for use with the wheel hub clutch 112. In the illustrated example, the stator 152 has two electromagnetically inductive coils 170 to create a magnetic flux when one or both electromagnetically inductive coils 170 are energized. The stator 152 applies a first magnetic control force to the translator 154 one way when the electromagnetically inductive coils 170 are energized to cause the translator 154 to move along the rotational axis A. The translator 154 reacts to the magnetic control force by moving the plunger plate 160 and corresponding plungers 157 along the rotational axis A. By reversing the current direction in the electromagnetically inductive coils 170, the translator 154 causes the plunger plate 160 and corresponding plungers 157 to move in the opposite direction along the rotational axis A.

The translator 154 rotates with the clutch hub 114, for example, by being splined thereto or otherwise coupled thereto against relative rotation. The translator 154 is supported for translational movement relative to the stator 152 along the rotational axis A between first and second axial end positions, corresponding to different operating modes of the wheel hub clutch 112. The translator 154 may include a magnet carrier 174, a permanent magnet 176 carried by the magnet carrier 174, a plunger plate hub 178 that may be coupled to the plunger plate 160 and disposed between the magnet carrier 174 and the plunger plate 160, and a snap ring 179 that may fit in a corresponding groove in the inner cylindrical wall 164 of the translator carrier 162 or any other suitable retention element or feature to limit travel of the magnet carrier 174.

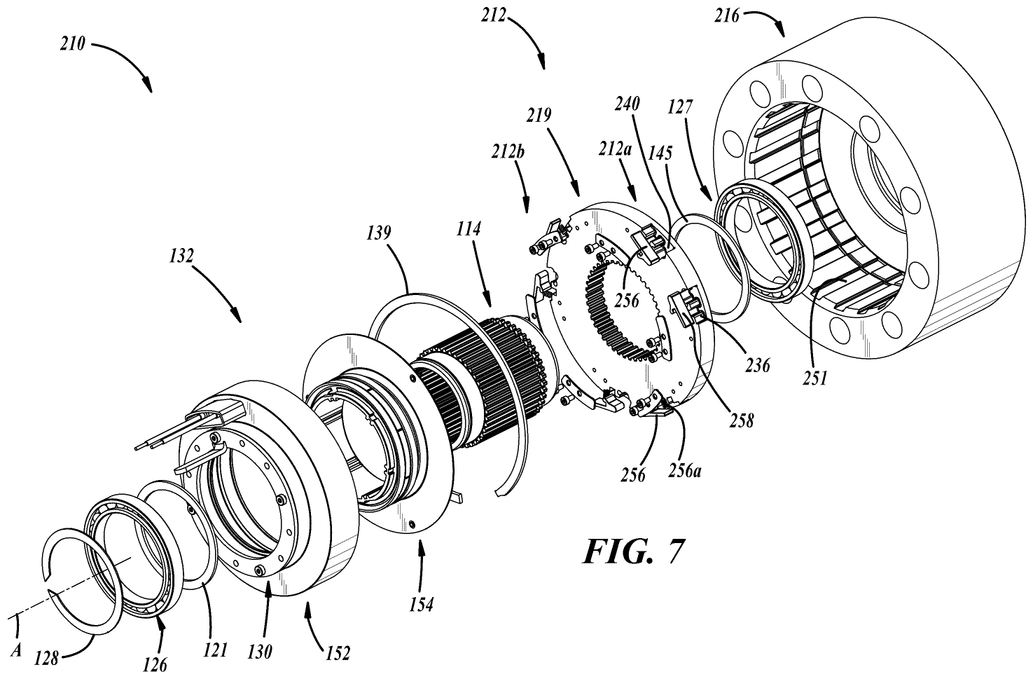

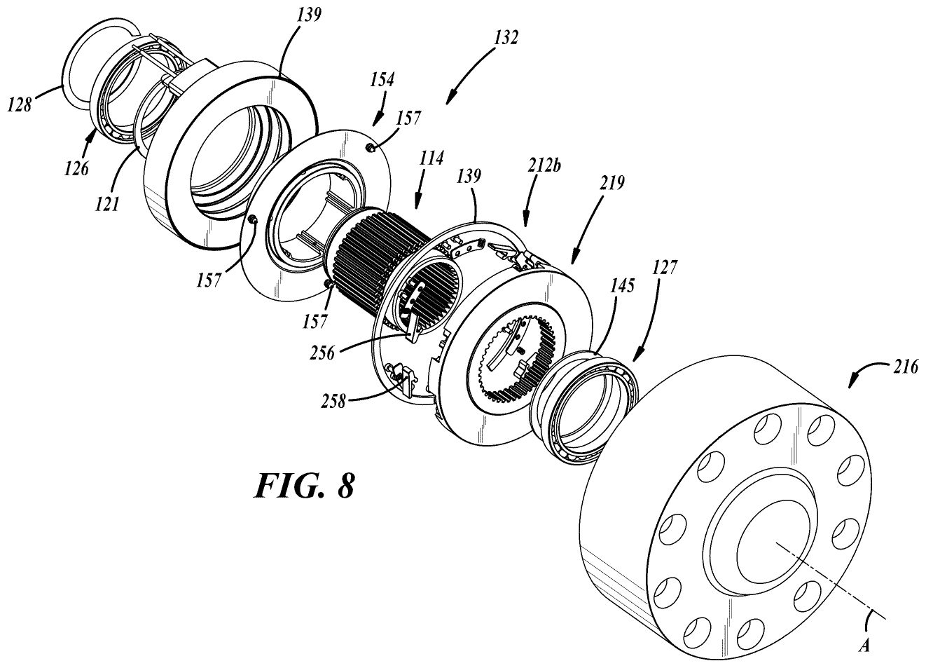

FIGS. 7-9B show a further illustrative embodiment of a wheel end 210 including a further embodiment of a wheel hub clutch 212. The wheel hub clutch 212 includes the clutch hub 114, a clutch component or race 219 coupled to the clutch hub 114, an active clutch 212a operatively disposed between the clutch race 219 and the wheel hub cover 216, and a passive clutch 212b operatively disposed between the clutch race 219 and the wheel hub cover 216.

The clutch race 219 may be a dual radial pocket plate having a first set of radial pockets 240 carrying first radial locking members or struts 256 and a second set of radial pockets 236 carrying second radial locking members or struts 258, in a radially outward portion of the clutch race 219. The first radial locking members or struts 256 may be actively actuated by a clutch actuator 232 and the second radial locking members or struts 258 may be passively actuated. The first and second struts 256, 258 are oriented in circumferentially opposite directions.

The wheel hub clutch illustrated in FIGS. 7-9 is an active and passive radial overrunning clutch. An example embodiment of a relevant clutch is described in U.S. Pat. No. 7,484,605, assigned to the assignee hereof, the contents of which is hereby incorporated herein by reference in its entirety. Another example embodiment of a relevant clutch, is described in U.S. Pat. No. 10,590,999, assigned to the assignee hereof, the contents of which is hereby incorporated herein by reference in its entirety. In the '999 patent, one set of radial pawls may be actively controlled, and a different set of radial pawls may be actively controllable but whose control is deactivated or turned off so as to operate in a passive overrunning mode.

Much of the wheel end 210 may be substantially the same as the wheel end 110 of FIGS. 4A-6C, including the bearings 126, 127, stator support 130, snap rings 128, 139, 145, thrust washer 121, and even the clutch hub 114 and the clutch actuator 132 including the stator 152 and the translator 154. The wheel hub clutch 212 itself and the wheel hub cover 216 have some similarities to that shown in FIGS. 4A-6C, but are different, as discussed below.

The clutch race 219 is coupled to the clutch hub 114 against relative rotation therebetween, and is disposed axially between the clutch actuator 132 and a transversely extending axial wall 248a of the wheel hub cover 216. More specifically, the clutch race 219 may be splined to the clutch hub 114. In other embodiments, the clutch race 219 may be integral with the clutch hub 114 such that the components are unitary. The clutch race 219 includes the radial pockets 240, which are active pockets in a radially outboard facing pocket surface of the clutch race 219. A longitudinally extending circumferential wall 246a of the wheel hub cover 216 includes notches 251 in a notch surface facing the pocket surface of the clutch race 219, and the notches 251 serve as both passive and active notches, such that the wheel hub cover 216 serves as a clutch race, more particularly, a notch race.

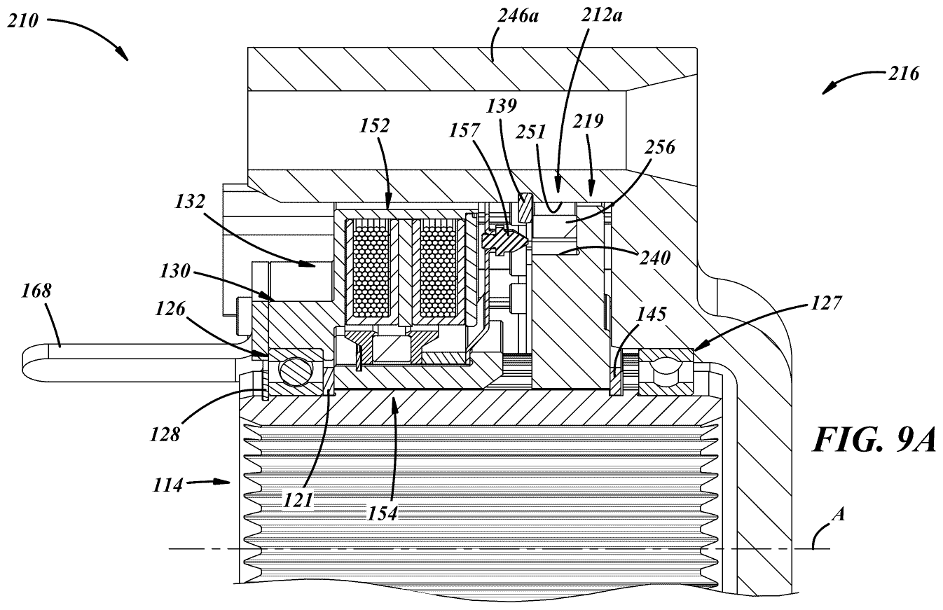

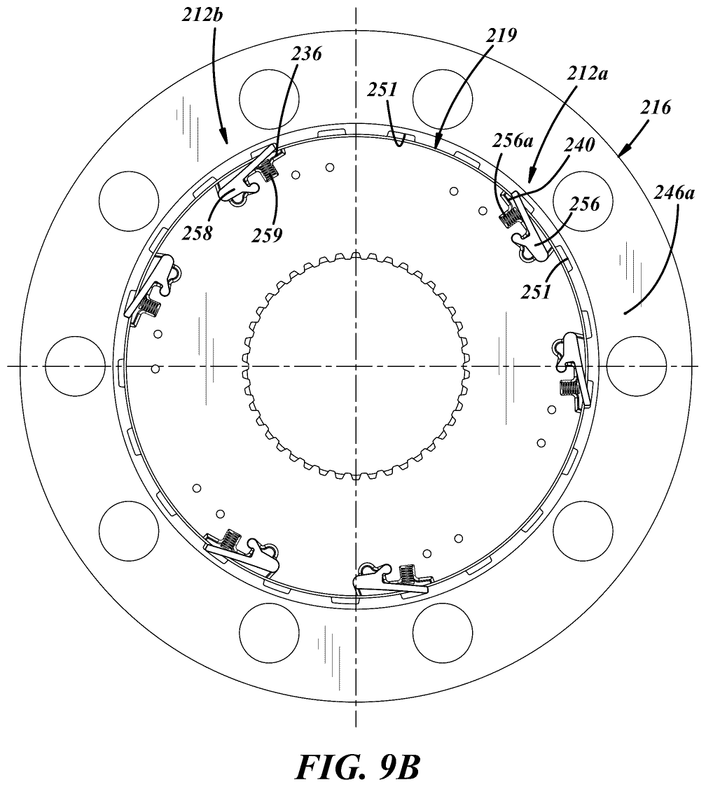

With reference to FIG. 9B, the active clutch 212a includes one or more active struts 256 between the active pockets 240 in the pocket surface of the clutch race 219 and the notches 251 in the notch surface of wheel hub cover 116. The active struts 256 may be biased to a deployed position by advance springs 256a. The active struts 256 of the active clutch 212a couple the clutch race 219 to the wheel hub cover 216 in the second direction of rotation only. The active clutch 212a also may include active actuator elements that may include the active plungers 157, wherein the clutch actuator 132 may include the active plungers 157 and, in any case, moves the active plungers 157 to, in turn, move the active struts 256 pivotally to a nondeployed position between the clutch race 219 and the wheel hub cover 216 such that the clutch race 219 becomes uncoupled from the wheel hub cover 216.

The passive clutch 212b includes one or more passive struts 258 between the notches 251 of the clutch race 219 and the passive pockets 236 in the radially outwardly facing pocket surface of the clutch race 219. The passive struts 258 of the passive clutch 212b couple the clutch race 219 and the wheel hub cover 216 in a first direction of rotation only and allows the clutch race 219 to overrun the wheel hub cover 216 in a second direction of rotation. The passive struts 258 may be biased to a deployed position by passive advance springs 259. More specifically, the passive clutch 212b also may include passive actuator elements that may include the passive advance springs 259 that bias and move the passive struts 258 toward and to a deployed position between the clutch race 219 and the wheel hub cover 216 such that the clutch race 219 becomes coupled to the wheel hub cover 216 in a first (forward) direction of rotation and overruns the wheel hub cover 216 in a second (reverse) direction of rotation.

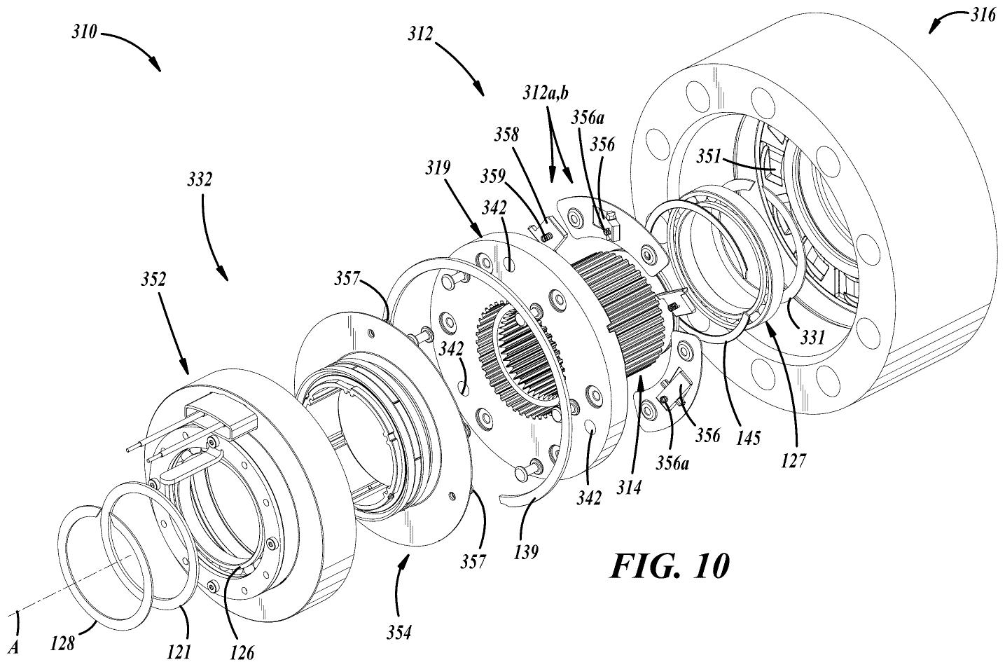

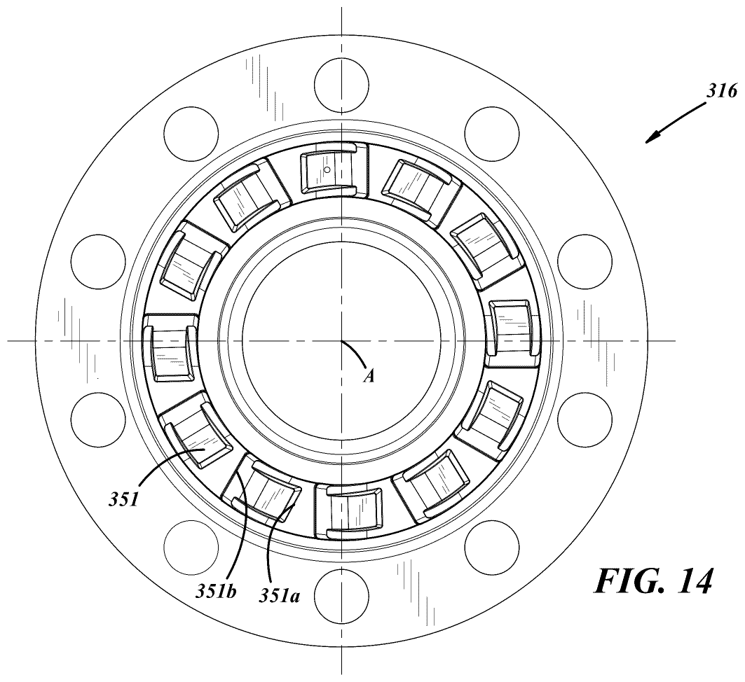

FIGS. 10-14 show an additional illustrative embodiment of a wheel end 310 including an additional embodiment of a wheel hub clutch 312. The wheel hub clutch 312 includes a clutch hub 314, a clutch component or race 319 coupled to the clutch hub 314, an active planar clutch 312a operatively disposed between the clutch race 319 and the wheel hub cover 316, and a passive planar clutch 312b operatively disposed between the clutch race 319 and the wheel hub cover 316.

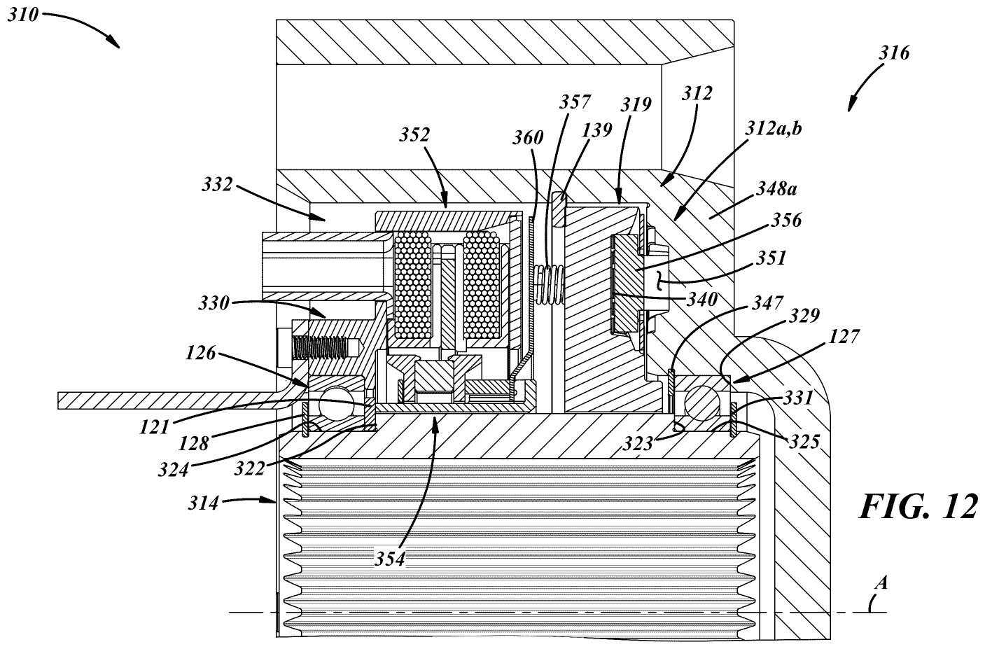

With reference to FIG. 12, the clutch hub 314 may include an inboard shoulder 322 and an adjacent inboard bearing journal 324 at an inboard end for carrying the inboard bearing 126 between the inboard shoulder 322 and the snap ring 128 or other retention element, wherein the thrust washer 121 may be disposed between the inboard shoulder 322 and the inboard bearing 126. The inboard bearing 326 may support a stator support 330 for a clutch actuator 332. The clutch hub 314 also may include an outboard shoulder 323 and an adjacent outboard bearing journal 325 at an outboard end for carrying the outboard bearing 127 at the outboard end radially between the clutch hub 314 and a shoulder 329 of a corresponding portion (such as a wheel hub cover) of the wheel hub cover 316 and/or a snap ring 331 carried in a corresponding groove of the clutch hub 314. The clutch hub 314 may include an internal spline for splined coupling to an axle shaft (not shown).

With reference to FIG. 12, the clutch actuator 332 may include a stator 352 supported by the stator support 330, and a translator 354 carried radially between the stator 352 and the clutch hub 314 between the bearing journals 324, 325 and may be axially retained thereto by the snap ring 128, the thrust washer, 121, and/or any other retention member(s) (not shown) coupled to the clutch hub 314.

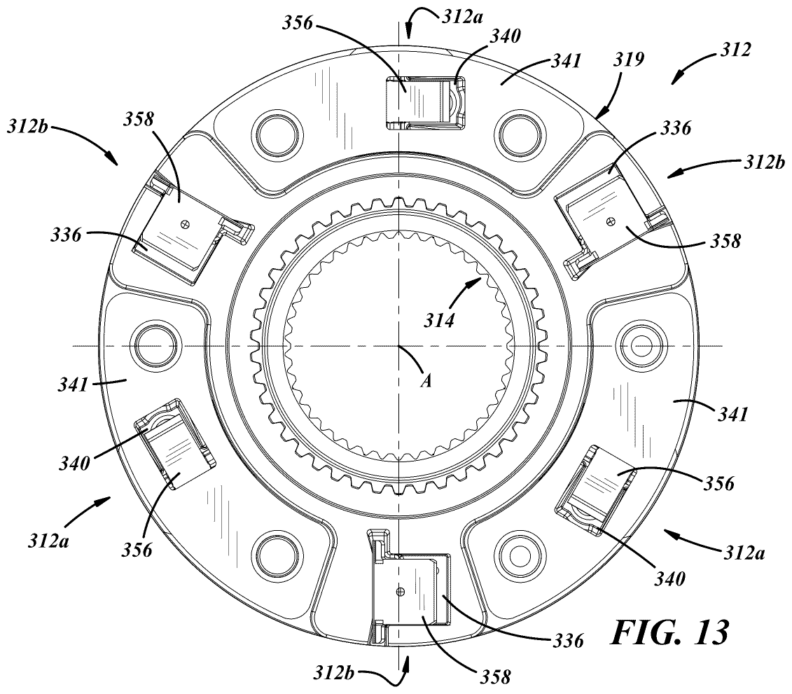

With reference to FIG. 13, the clutch component or race 319 may be a single plane pocket plate having a plurality of active pockets 340 carrying a plurality of active locking members or struts 356 and a plurality of passive pockets 336 carrying a plurality of passive locking members or struts 358, in an outboard side of the clutch race 319. The clutch race 319 also may include a plurality of actuator passages 342 (FIG. 10) extending through the clutch race 319 between the outboard side and an inboard side and in communication with the plurality of active pockets 340. The clutch race 319 may be splined or otherwise coupled against rotation with respect to the clutch hub 314, and may be axially retained with respect to the wheel hub cover 316 by the snap ring 139 (FIG. 12) or other retention member coupled to the wheel hub cover 316.

The wheel hub clutch 312 illustrated in FIGS. 10-14 is a single plane active and passive overrunning clutch. Example embodiments of a relevant clutch are described in U.S. patent application Ser. No. 17/994,310, filed on Nov. 26, 2022, docket number MINS135CIP-US and published as US 2023/0160461, assigned to the assignee hereof, the contents of which is hereby incorporated herein by reference in its entirety.

Much of the wheel end 310 may be substantially the same as the wheel end 210 of FIGS. 7-9B, including the bearings 126, 127, snap rings 128, 139, and the thrust washer 121, except a snap ring 347 that may be carried in a corresponding groove of the wheel hub cover 316 to retain the outboard bearing 127. But the wheel hub clutch 312 itself and the wheel hub cover 316 have some similarities to that shown in FIGS. 7-9B, but are different, as discussed below.

The clutch race 319 is coupled to the clutch hub 314 against relative rotation therebetween, and is disposed axially between the actuator 332 and a transversely extending axial wall 348a of the wheel hub cover 316. More specifically, the clutch race 319 may be splined to the clutch hub 314. In other embodiments, the clutch race 319 may be integral with the clutch hub 314 such that the components are unitary. The clutch race 319 includes the active pockets 340, which are axial pockets in an axially outboard facing pocket surface of the clutch race 319. The transversely extending axial wall 348a of the wheel hub cover 316 includes notches 351 in a notch surface facing the pocket surface of the clutch race 319, and the notches 351 serve as both passive and active notches, such that the wheel hub cover 316 serves as a clutch race, more particularly, a notch plate. The notches have active strut engagement features 351a, and passive strut engagement features 351b that are oriented circumferentially opposite of the active strut engagement features 351a.

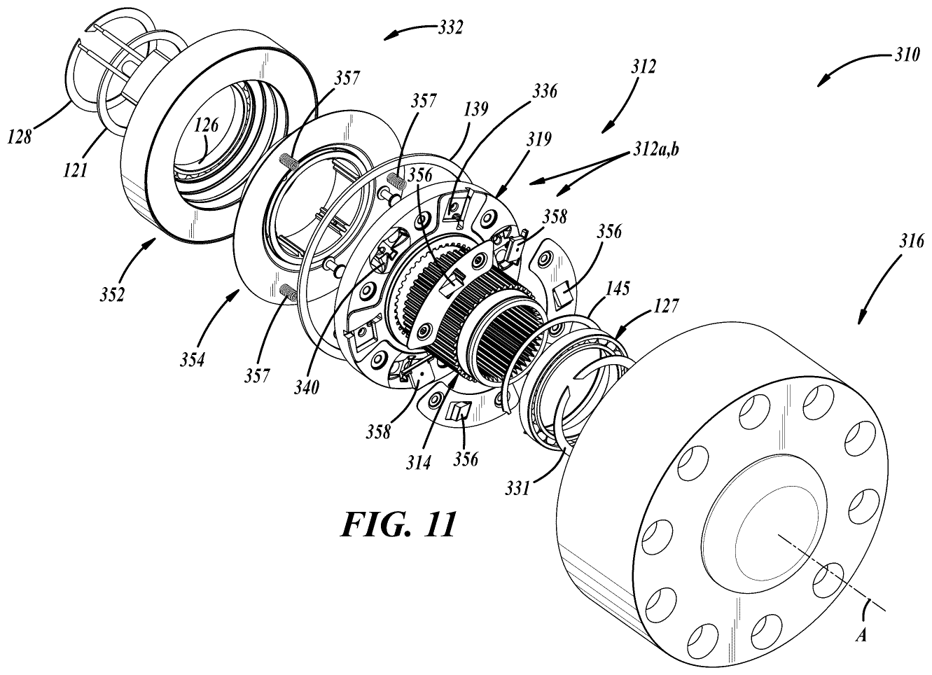

With reference to FIGS. 10-11, the active clutch 312a includes one or more active struts 356 between the active pockets 340 in the pocket surface of the clutch race 319 and the notches 351 in the notch surface of wheel hub cover 316. The active struts 356 may be biased to a nondeployed position by return springs 356a. The active struts 356 of the active clutch 312a couple the clutch race 319 in the second direction of rotation only. The active clutch 312a also may include active actuator elements that may include active plungers 357, wherein the clutch actuator 332 may include the active plungers 357 and, in any case, moves the active plungers 357 to, in turn, move the active struts 356 pivotally to a deployed position between the clutch race 319 and the wheel hub cover 316 such that the clutch race 319 becomes coupled to the wheel hub cover 316 in the second direction of rotation. The active plungers 357 may include coil springs, as illustrated, or plungers with conical heads, or any other suitable strut actuator elements.

The passive clutch 312b includes one or more passive struts 358 carried in the passive pockets 336 of the clutch race 319 and between the clutch race 319 and the axial notches 351 in the axially inwardly facing notch surface of the wheel hub cover 316. The passive struts 358 of the passive clutch 312b couple the clutch race 319 and the wheel hub cover 316 in a first direction of rotation only and allow the clutch race 319 to overrun the wheel hub cover 316 in the second direction of rotation. More specifically, the passive clutch 312b may include passive actuator elements that may include passive advance springs 359 (FIG. 10) that bias and move the passive struts 358 toward a deployed position between the clutch race 319 and the wheel hub cover 316 such that the clutch race 319 becomes coupled to the wheel hub cover 316 in a first (forward) direction of rotation and overruns the wheel hub cover 316 in a second (reverse) direction of rotation.

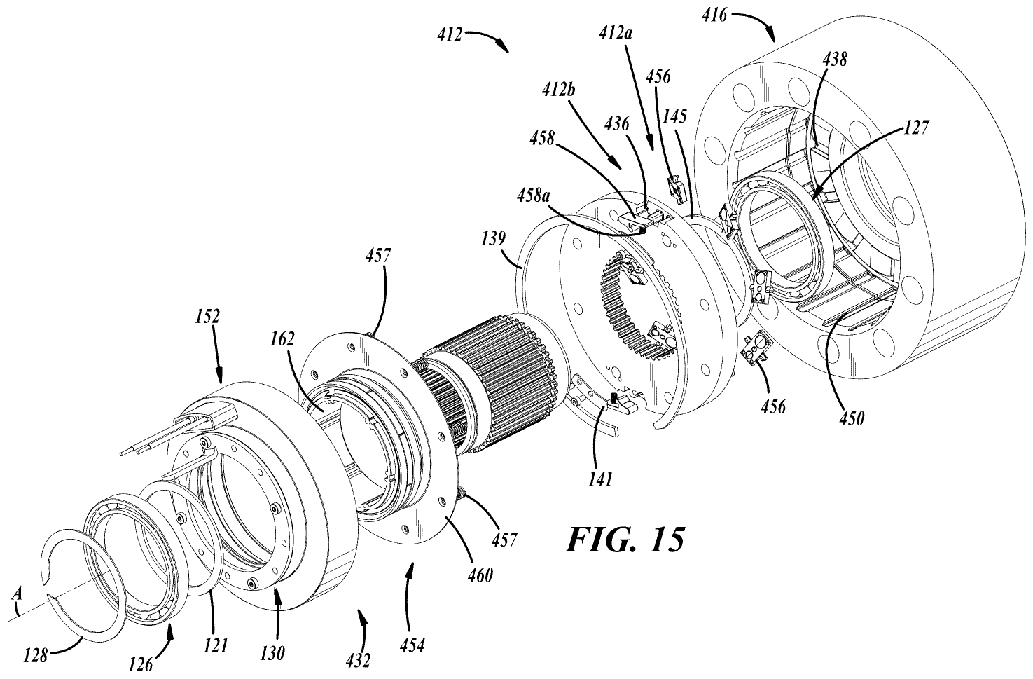

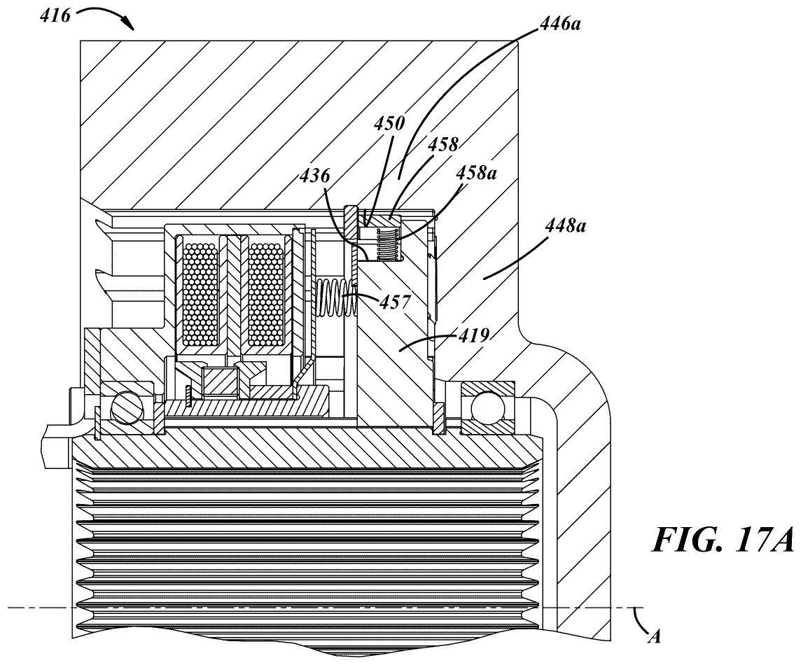

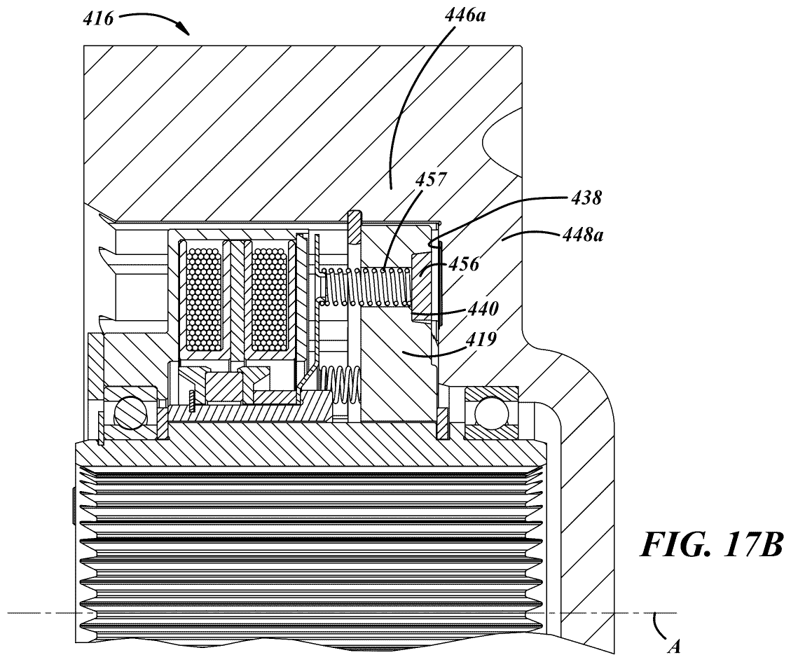

FIGS. 15-17B show yet another illustrative embodiment of a wheel end 410 including yet another embodiment of a wheel hub clutch 412. The wheel end 410 and clutch 412 are most similar to that illustrated in FIGS. 4A-6C. The wheel hub clutch 412 includes the clutch hub 114, a clutch component or race 419 coupled to the clutch hub 114, an active planar clutch 412a that is operatively disposed between the race 419 and a wheel hub 416, and a passive radial clutch 412b that is operatively disposed between the race 419 and the wheel hub 416.

The race 419 may be a combination radial pocket plate and axial pocket plate, with axial pockets 440 on an outboard side and radial pockets 436 on a radially outward portion. In the illustrated embodiment, the race 419 may be splined to the clutch hub 114. In other embodiments, the race 419 may be integral with the clutch hub 114 such that the components are unitary, or the race 419 may be otherwise coupled against relative rotation with respect to the clutch hub 114.

Much of the wheel end 410 may be substantially the same as the wheel end 410 of FIGS. 4A-6C, including the bearings 126, 127, stator support 130, snap rings 128, 139, 145, thrust washer 121, and even the clutch hub 114 and the clutch actuator 132 including the stator 152. The wheel hub clutch 412 itself and the wheel hub cover 416 have some similarities to that shown in FIGS. 4A-6C, but are different, as discussed below.

The wheel hub clutch 412 illustrated in FIGS. 15-17B is an active planar and passive radial overrunning clutch. Example embodiments of a relevant clutch are described in U.S. Pat. No. 8,079,453, assigned to the assignee hereof, the contents of which is hereby incorporated herein by reference in its entirety.

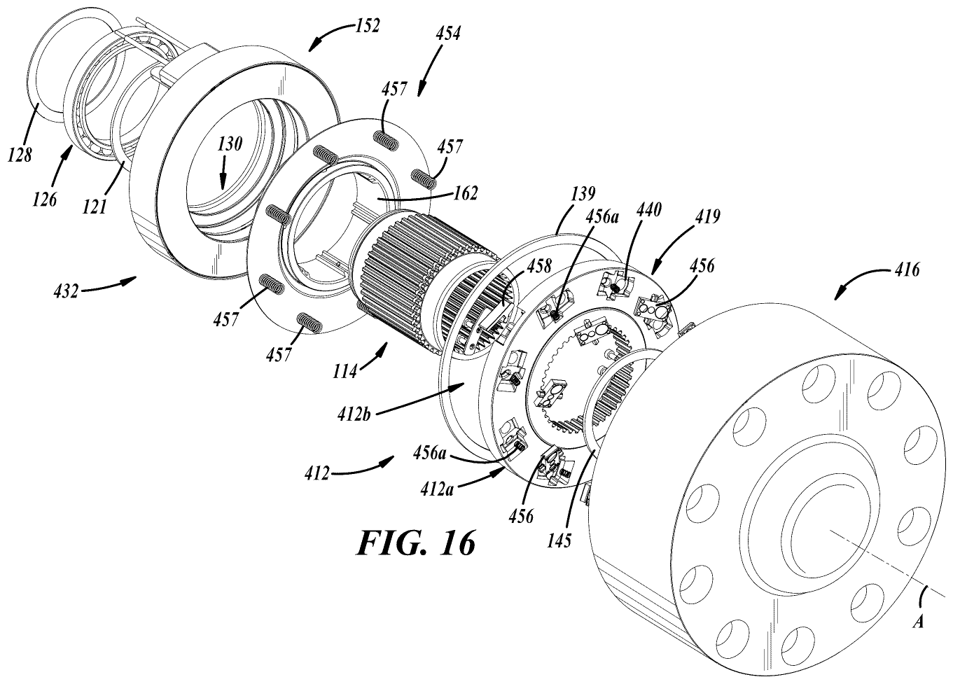

The clutch race 419 may be a combination radial pocket plate and axial pocket plate, with passive radial pockets 436 (FIG. 15) in a radially outward portion and active axial pockets 440 (FIG. 16) in an axial outboard side. A transversely extending axial wall 448a of a wheel hub cover 416 includes axial notches 438, which are passive notches in an axially inboard facing passive notch surface of the transversely extending axial wall 448a of the wheel hub cover 416. Also more specifically, a longitudinally extending circumferential wall 446a of the wheel hub cover 416 includes passive notches 150 in a passive notch surface facing the passive pocket surface of the clutch race 419, such that the wheel hub cover 416 serves as a clutch race, more particularly, a notch race. Similarly, the axial pockets 440, are active pockets, in the active pocket surface facing the active notch surface of the transversely extending axial wall 448a of the wheel hub cover 416, such that the wheel hub cover 416 additionally serves as a clutch race, more particularly a notch plate.

The active clutch 412a includes one or more active struts 456 between the active pockets 440 in the active pocket surface of the clutch race 419 and the active notches 438 in the active notch surface of wheel hub cover 416. The active struts 456 may be biased toward a nondeployed position by return springs 456a. The active struts 456 of the active clutch 412a couple the clutch race 419 in the second direction of rotation only. The active clutch 412a also may include active actuator elements that may include active plungers 457, wherein the clutch actuator 432 may include the active plungers 457 and, in any case, moves the active plungers 457 to, in turn, move the active struts 456 pivotally to a deployed position between the clutch race 419 and wheel hub cover 416 such that the clutch race 419 becomes coupled to the wheel hub cover 416.

The passive clutch 412b includes one or more passive struts 458 between the passive pockets 436 of the clutch race 119 and the passive notches 450 of the wheel hub cover 116. The passive struts 458 of the passive clutch 412b couple the clutch race 419 and the wheel hub cover 416 in a first direction of rotation only and allows the clutch race 419 to overrun the wheel hub cover 416 in a second direction of rotation. The passive struts 458 may be biased to a deployed position by passive advance springs 458a. More specifically, the passive clutch 412b also may include passive actuator elements that may include the passive advance springs 458a that bias and move the passive struts 458 toward a deployed position between the clutch race 419 and the wheel hub cover 416 such that the clutch race 419 becomes coupled to the wheel hub cover 416 in a first (forward) direction of rotation and overruns the wheel hub cover 416 in a second (reverse) direction of rotation.

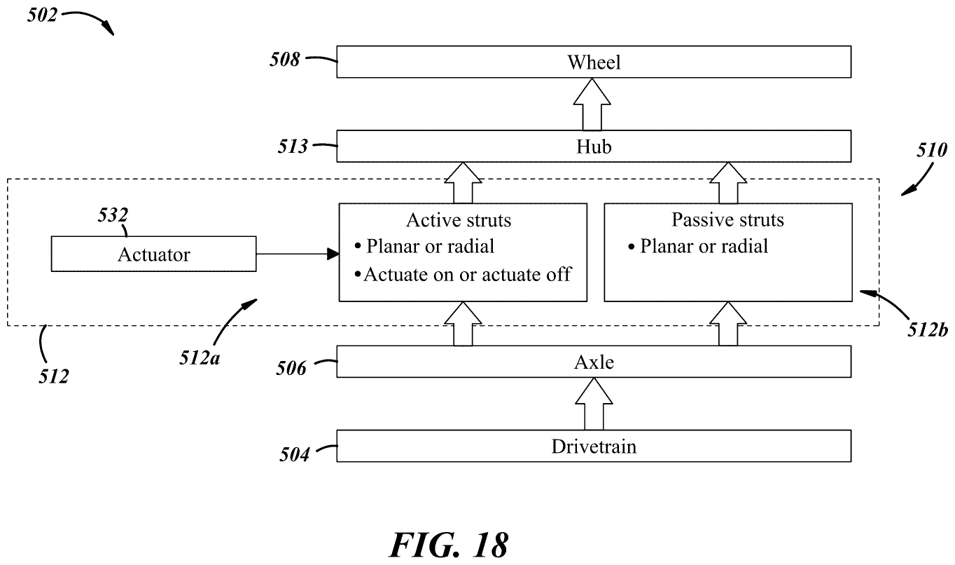

FIG. 18 schematically shows an embodiment of a vehicle 502 that includes an apparatus including a drivetrain 504, an axle 506, a wheel 508, and a wheel end 510 that includes a wheel hub 513 and that couples the wheel 508 to the axle 506 via a wheel hub clutch 512 between the axle 506 and the wheel hub 513. The wheel hub clutch 512 includes an active clutch 512a and a passive clutch 512b. The active clutch 512a is actuated by an actuator 532 and includes planar struts and/or radial struts. The actuator 532 may actuate the struts from an off or disengaged position to an on or engaged position, or the actuator 532 may actuate the struts from the on or engaged position to the off or disengaged position. The passive struts may include planar and/or radial struts and are normally biased toward an engaged position. Although not shown, the clutch 512 also may include a clutch hub, one or more clutch components or races, and/or any of the other components described and/or illustrated in the embodiments of FIGS. 1-17B. Accordingly, FIGS. 1-17B show several specific examples that are encompassed by the apparatus of FIG. 18.

The vehicle 502 may be a wheeled vehicle of any suitable type having wheels, for example, a passenger automobile, a cargo truck, an all-terrain vehicle, a camper, a bus, a tractor, a motorcycle, a trike, or any other vehicle suitable for use with the presently disclosed subject matter. Although not separately shown, the drivetrain 504 may include, or may be powered by, one or more prime movers, for example, an electric motor and/or a combustion engine. Accordingly, the drivetrain 504 may be part of a powertrain that may include an internal combustion engine, a transmission having an upstream end coupled to the engine and a downstream end coupled to the drivetrain, or simply may be an output shaft of an electric motor, or may be provided according to any other configuration suitable with the presently disclosed subject matter. The axle 506 may be a downstream portion of the drivetrain 504 or may be a separate entity downstream of the drivetrain 504 and may include an axle shaft for coupling to the wheel hub clutch 512, for instance, to a clutch hub of the wheel hub clutch 512.

The wheel hub clutch 512 operates in a one-way clutch mode or a fixed mode. A one-way clutch mode direction is set according to a vehicle forward direction and, therefore, would be rotationally clockwise on one side of the vehicle 502 and rotationally counter-clockwise for an opposite side of the vehicle 502. During normal driving operation, the clutch 512 can operate in the fixed mode in which forward and reverse torque can be applied from the drivetrain 504 to the wheel 508 in vehicle forward and reverse directions as well as back driven from the wheel 508 during engine braking, regenerative braking, or the like. The clutch 512 can also switch from the fixed mode to the one-way clutch mode, wherein the vehicle 502 can coast in the vehicle forward direction and the wheel 508 can move faster than or overrun the drivetrain 504. This mode provides low drag during vehicle coasting for better efficiency without the need to shift the drivetrain 504 of the vehicle 502 to a neutral state. From this one-way clutch mode, the rotational speed of the drivetrain 504 can be increased (e.g., by increasing prime mover rotational speed) so that the clutch 512 reengages the axle 506 to the wheel hub 513 as the rotational speed of the driveline 504 increases to match the rotational speed of the wheel 508. This one-way clutch mode is also useful during towing of the vehicle 502 wherein the drivetrain 504 is not back driven during towing, which back driving would cause excessive drag to a tow truck and possible damage to the drivetrain 504 and/or prime mover. The two clutch modes can be changed during vehicle operation to switch back and forth to the desired mode via the actuator 532 coupled to the active clutch 512a. Depending on a particular vehicle implementation, the actuator 532 can act to move the active clutch 512a from an engaged state to a disengaged state, or from the disengaged state to the engaged state. Drivetrain torque, speed, and packaging space may dictate which configuration is the best with many different combinations of planar and radial style struts in the active and passive portion of the clutch 512.

The presently disclosed clutches may be characterized as having 0/1, 1/1 strut/pawl positions according to the following nomenclature. The clutches may have multiple strut/pawl positions, for example, up/out/uncovered or down/in/covered. The nomenclature (/) refers to rotational direction, clockwise and counterclockwise (CW/CCW), wherein the first refers to the clockwise direction, and the second refers to the counterclockwise direction. A 1 means struts/pawls up/out/uncovered/advanced, either in a clutch lock or overrun condition, whereas a 0 means strut down/in/covered/retracted, free in either rotational direction such that clutch races are disengaged relative to one another. For example, (1/1) means both strut/pawl sets up, lock in both CW and CCW rotational directions, and (0/1) means lock in CCW rotation, or overrun with CW rotation. The term “disengaged” means that the struts are actively retracted such that the races are freely rotatable relative to one another in either circumferential direction at any instant. The term “overrun” generally means that one rotational member is free to rotate relatively faster than another rotational member and, specifically means with respect to a strut clutch that the struts extend, or are free to extend, toward their advanced positions but are rotationally bypassed (and may be contacted) by one of the races such that the struts do not carry torque between the races. CW and CCW may be considered from a viewpoint looking in an axially outboard-toward-inboard direction, as if looking at a wheel on a vehicle along an axis of an axle shaft for the wheel. For example, a right wheel of a vehicle will rotate clockwise in a vehicle forward direction whereas a left wheel of a vehicle will rotate counter clockwise in a vehicle forward direction. Consequently the right wheel may have a CW-drive configured clutch whereas the left wheel may have a CCW-drive configured clutch, for instance, as a mirror image of the CW-drive configured clutch.

Although the illustrated struts are shown as planar struts and radial struts pivotable about a single axis, the struts may be configured as spherical struts, sprag struts or sprag-like struts, roller struts, or any other strut shape configurations pivotable about one or more axes, and suitable to be advanced and retracted toward and away from engagement with a clutch race.

The descriptions of the several embodiments described and incorporated above and illustrated in the drawing figures are hereby incorporated by reference into one another, and descriptions of subject matter common to the embodiments generally may not be repeated. Accordingly, from the disclosure and teachings herein combined with the disclosure and teachings in the incorporated documents, a multitude of combinations of structures and functions are disclosed even if not all explicitly illustrated in the drawing figures.

Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. As such, many other embodiments, modifications, and equivalents thereto, either exist now or are yet to be discovered and, thus, it is neither intended nor possible to presently describe all such subject matter, which will readily be suggested to persons of ordinary skill in the art in view of the present disclosure. Rather, the present disclosure is intended to embrace all such embodiments and modifications of the subject matter of this application, and equivalents thereto, as fall within the broad scope of the accompanying claims.

1. An active and passive overrunning wheel hub clutch, comprising:
a clutch hub;
a wheel hub;
an active clutch between the clutch hub and the wheel hub; and
a passive clutch between the clutch hub and the wheel hub.

2. The clutch of claim 1 further comprising:
a first clutch component coupled to the clutch hub;
a second clutch component coupled to the wheel hub;
the active clutch between the first and second clutch components; and
the passive clutch between the first clutch component and the wheel hub,
wherein the clutch is a dual plane clutch.

3. The clutch of claim 2 wherein
the wheel hub includes a wheel hub cover that is a cup-shaped member having a transversely extending axial wall and a longitudinally extending circumferential wall that is internally splined;
the second clutch component is a race coupled to the longitudinally extending circumferential wall of the wheel hub cover; and
the first clutch component is a race coupled to the clutch hub and is disposed between the second clutch component and the transversely extending axial wall of the wheel hub cover.

4. The clutch of claim 3 wherein:
the second clutch component is splined to the longitudinally extending circumferential wall of the wheel hub cover and includes an active pocket in an active pocket surface;
the transversely extending axial wall of the wheel hub cover includes a passive notch in a passive notch surface; and
the first clutch component is splined to the clutch hub and includes an active notch in an active notch surface facing the active pocket surface of the second clutch component, and a passive pocket in a passive pocket surface facing the passive notch surface of the transversely extending axial wall of the wheel hub cover.

5. The clutch of claim 4 wherein:
the active clutch includes an active strut between the active pocket in the active pocket surface of the second clutch component and the active notch in the active notch surface of the first clutch component; and
the passive clutch includes a passive strut between the passive pocket of the first clutch component and the passive notch in the transversely extending axial wall of the wheel hub cover.

6. (canceled)

7. The clutch of claim 2 wherein:
The passive clutch includes a passive spring and a passive strut, the passive spring moves the passive strut to a deployed position between the first clutch component and wheel hub such that the first clutch component is coupled to the wheel hub in a first direction of rotation and overruns the wheel hub in a second direction of rotation; and
the active clutch includes an active spring, an active strut, and an actuator, the actuator acting on the active spring to move the active strut pivotally to a deployed position between the second clutch component and the first clutch component such that the first clutch component is coupled to the second clutch component in the second direction of rotation.

8. The clutch of claim 7 wherein the actuator includes:
a stator structure;
a translator structure; and
a strut actuator element positioned between the translator structure and the active strut.

9. The clutch of claim 1 further comprising:
a clutch component coupled to the clutch hub;
the active clutch between the clutch component and the wheel hub; and
the passive clutch between the clutch component and the wheel hub.

10. The clutch of claim 9 wherein
the active clutch is an active radial clutch ox an active planar clutch; and
the passive clutch is a passive planar clutch or a passive radial clutch.

11. The clutch of claim 10 wherein
the active clutch includes a radial pocket in a radially outer portion of the clutch component, a radial notch in a radially inner portion the wheel hub, and a radial strut carried in the radial pocket; and
the passive clutch includes an axial pocket in an outboard face of the clutch component, an axial notch in an inboard face of the wheel hub, and a planar strut carried in the axial pocket.

12. The clutch of claim 10 wherein
the active clutch further includes an actuator to radially outwardly displace a strut, wherein the clutch component is disposed axially between the actuator and an inboard face of the wheel hub.

13. The clutch of claim 12 wherein
the actuator is coupled to the wheel hub radially within a longitudinally extending circumferential wall of the wheel hub.

14. (canceled)

15. The clutch of claim 10 wherein
the active clutch includes an active radial pocket in an active radially outer portion of the clutch component, an active radial notch in an active radially inner portion the wheel hub, and an active radial strut carried in the active radial pocket; and
the passive clutch includes a passive axial pocket in a passive radially outer portion of the clutch component circumferentially spaced from the active radially outer portion, a passive axial notch in a passive radially inner portion of the wheel hub circumferentially spaced from the active radially inner portion, and a passive radial strut carried in the passive radial-axial pocket.

16. (canceled)

17. (canceled)

18. (canceled)

19. The clutch of claim 10 wherein
the clutch is a single plane clutch;
the active clutch includes an active axial pocket in an outboard face of the clutch component, an active axial notch in an inboard face of the wheel hub, and an active axial strut carried in the active axial pocket; and
the passive clutch includes a passive axial pocket in the outboard face of the clutch component, a passive axial notch in the inboard face of the wheel hub, and a passive axial strut carried in the passive axial pocket, wherein the passive axial pocket, the passive axial notch, and the passive axial strut are all circumferentially spaced from the active axial pocket, the active axial notch, and the active axial strut.

20. (canceled)

21. (canceled)

22. (canceled)

23. The clutch of claim 10 wherein
the passive clutch includes a radial pocket in a radially outer portion of the clutch component, a radial notch in a radially inner portion the wheel hub, and a radial strut carried in the radial pocket; and
the active clutch includes an axial pocket in an outboard face of the clutch component, an axial notch in an inboard face of the wheel hub, and a planar strut carried in the axial pocket.

24. (canceled)

25. (canceled)

26. An apparatus, comprising:
an axle;
a wheel hub; and
an active and passive overrunning wheel hub clutch disposed between the axle and the wheel hub.

27. The apparatus of claim 26, wherein the active and passive overrunning wheel hub clutch includes:
a clutch hub;
a wheel hub;
an active clutch between the clutch hub and the wheel hub; and
a passive clutch between the clutch hub and the wheel hub.

28. A vehicle, comprising:
the apparatus of claim 26;
a drivetrain coupled to the axle; and
a wheel coupled to the wheel hub.

29. A wheel end, comprising:
a wheel hub cover, and
an active and passive overrunning wheel hub clutch coupled to the wheel hub cover.

30. The wheel end of claim 29, wherein the active and passive overrunning wheel hub clutch is retained to the wheel hub cover by at least one retainer ring such that the wheel hub cover and the active and passive overrunning wheel hub clutch constitute a self-contained assembly.
